(19) United States
(12) Patent Application Publication
(10) Pub. No.: US 2021/0308630 A1
(43) Pub. Date: Oct. 7, 2021

(54) Support for Nano-Thickness Membranes

(71) Applicants: Ralph Aaron Bauer, Houston, TX (US); Hendrik Verweij, Takoma Park, MD (US)

(72) Inventors: Ralph Aaron Bauer, Houston, TX (US); Hendrik Verweij, Takoma Park, MD (US)

(21) Appl. No.: 17/220,447

(22) Filed: Apr. 1, 2021

Related U.S. Application Data
(60) Provisional application No. 63/006,120, filed on Apr. 7, 2020.

(51) Int. Cl. B01D 69/10; B01D 69/04; B01D 71/06; B01D 71/02; B01D 69/02; B01D 69/06; B01D 53/22

(52) U.S. Cl. CPC B01D 69/10; B01D 69/04; B01D 71/06; B01D 71/02; B01D 69/02; B01D 2325/20; B01D 53/228; B01D 2325/02; B01D 2325/04; B01D 2325/06; B01D 69/06

(57) ABSTRACT

A porous support for nano-thickness membranes of less than 100 nanometers local surface roughness, suitable for the support of single-layer membranes of from about 1 to 500 nanometers in thickness, and for multiple layer membranes of up to about 2000 nanometers in aggregate thickness. The support also has a surface pore size of less than 100 nanometers and a surface porosity of less than 50 percent.

### CROSS REFERENCE TO RELATED APPLICATIONS

This application claims the benefit of U.S. Provisional Patent Application 63/006,120; filed Apr. 7, 2020.

### STATEMENT REGARDING FEDERALLY SPONSORED RESEARCH AND DEVELOPMENT

Not applicable.

### TECHNICAL FIELD

The present disclosure relates generally to the field of supports for thin film membranes, specifically to a porous support for the support of nano-thickness membranes.

### BACKGROUND OF THE INVENTION

Thin film membranes on porous supports are emerging as a preferred method for gas and liquid separation. These thin films are referred to as “nano-thickness membranes.” These nano-thickness membranes occur in single or multiple layers with individual layers of 1-500 nanometer (nm) thickness and with multiple layers from 10-2000 nm in aggregate thickness. The first nano-thickness membrane layer needs to be deposited onto a homogeneous porous support with a local surface roughness of <100 nm; such supports are generally made of a ceramic material, like α-Al₂O₃, however the porous support material can be of any composition, examples include TiO₂, ZrO₂, BN, Ni, and polypropylene. Local surface roughness refers to variation in the support surface, perpendicular to the average surface over a length of 10 μm. Nano-thickness membranes can be used for the separation and production of gases such as O₂, N₂, H₂, CO₂, etc. and for water purification by removing particles such as clay platelets, living organisms such as bacteria, and dissolved salts such as NaCl. The porous supports must have a porosity of 5-95%, preferably around 35% to maintain mechanical strength. The local surface roughness generally must be less than 100 nm to allow the deposition of uniform defect free membrane layers that are in the 1-500 nm thickness range.

Viable separation of gases and liquids with nano-thickness membranes depends on the success of depositing the nano-thickness membranes on the porous support. The development of porous, nano-smooth, supports is one of the objects of this disclosure. The geometry of the supports as it appears to the naked eye can be planar, tubular or any shape that is compatible with the membrane's use. It can be made by extrusion, casting, or other manufacturing processes.

Examples of extruded shapes are single and multi-channel tubes. However, the challenge for such shapes is producing a local support surface roughness of <100 nm. Extruded tubes have a surface roughness of >10 microns with low porosities of <35% porous. Such high surface roughness means that homogenous, continuous, defect-free nano-membranes cannot be applied. Currently one or more “repair” layers must be applied atop the as-extruded surface before any functional membrane layers can be formed. The repair layers increase the transport resistance of the supported membrane structure, make it less defined and thus lower the total system performance. In addition, the use of repair layers almost never leads to a perfect result so that the eventual functional membrane layer can become too thick and yet still not defect-free. A porous support with local surface roughness of <100 nm is needed for defect-free deposition of single-layer membranes with a thickness of 1-500 nm and multiple layers that can total up to 2000 nm in aggregate thickness. Defects in membrane layers include pores, larger than 1 nm, that form a connection between one membrane side (feed) and the other (permeate) side. Such pores allow gas or liquid mixtures to cross the membranes with a high flux and low selectivity. A near complete absence of defects is needed in membranes to ensure selectivities greater than 10. This selectivity is defined as molar ratio of the flows through the membrane of the target purified compound—to that of the other compound

In agreement with the local surface roughness requirements, the supports for the membranes must have a surface pore size of <100 nm and a surface porosity of <50%. The bulk porosity and pore size and structure throughout the support structure must be such that the support does not adversely affect membrane transport (by contributing >50% to the gas or liquid transport resistance). Porous supports must be structurally and thermally stable at application temperatures, for instance 500° C. and application pressures, for instance 100 MPa and pressure differences, for instance 10 MPa.

### SUMMARY OF THE INVENTION

This invention describes porous supports with a local surface roughness that is sufficiently low (less than 100 nm) for the deposition of defect-free nano-thickness membrane layer(s) on to the supports and a microstructure that adds less than 50% to the overall transport resistance of the complete membrane structure.

### DETAILED DESCRIPTION OF EXAMPLE EMBODIMENTS

To produce a defect-free supported nano-thickness membrane structure (with single layers in the 1-500 nm thickness range and multi-layers up to 2000 nm total thickness), the membranes must be deposited on a porous support with sufficient mechanical strength to support the membrane, without surface defects and a local surface roughness of less than 100 nm on any location of the membrane deposition area of the support. This can be achieved, for instance, by making the support through assembly of particles followed by thermochemical processing such as drying, oxidation and conversion of added components, and sintering. In this process the particle size, shape, and extent of agglomeration must be controlled. Sintering is a surface-energy-driven process in which touching particles from strong necks so that the overall structure obtains sufficient strength. Surface defects are deviations from the quasi-homogeneous microstructure that adversely affects membrane quality. Examples of surface defects are support surface pores with a diameter that are much larger than the average pore diameter and particles in or on the surface that are much larger than the average grain size. Particles at the surface with a shape that deviates substantially from spherical are also considered defects. Large support surface pores are often caused by bubbles and low-density agglomerates that collect at the support surface during processing. Large particles are often caused by airborne contamination or abrasion from processing equipment. For extruded and/or polished support surfaces, the surface roughness is limited and/or defined by abrasion from the processing equipment, for example the extrusion spider dye, or the grit of the media being used in polishing. Polishing of the support surface also results in a lowering of open, or useable, porosity and unwanted introduction of debris into the membrane pores.

Applications for membranes include high-selectivity gas separation and liquid purification, sensing and electrochemical conversion devices. The full range of applications may include, but is not limited to, production of fuel cells, electrochemical pumps, chemicals, polymers, steel, petro-chemicals, semiconductor devices, gas separation, energy-conversion, environmental applications, agriculture, and the food and drink industries. The separation of oxygen and hydrogen are two examples where nano-thickness membranes on porous inorganic ceramic supports can have a major impact.

Other examples of use, as would be known by one skilled in the art, are for the sequestration of carbon dioxide gas and wastewater treatment. The support may be used to carry membranes for the separation of gases such as O₂, N₂, H₂, CO₂, and He, as well as the purification of liquids such as water.

The porous supports as described in this disclosure have a local surface roughness of <100 nm, a porosity of 5-45%,with a microstructure, thermal and structural properties that enable the deposition of nano-thickness membrane layer or layers for a range of applications described in this disclosure.

A method for making the support may begin with the provision of a powder that is processed into mostly individually mobile particles with a size of 50 nm to 20 μm. The powder may then be mixed with a binder and liquid medium to form a dispersion. The dispersion may then be formed into a flat plate or tube or any usable geometry using a colloidal casting process. This process results in a particle packing with a porosity of 30-40% and a support surface roughness of <25 nm, with a surface pore size of ˜40 nm. After casting, the “green” tube is dried in a controlled environment. After drying the tube is heated in a controlled environment from 100 to 1000° C. The tube is then inspected for any defects and possibly used for the deposition of one or more nano-membrane layers.

Numerous alterations, modifications, and variations of the preferred embodiments disclosed herein will be apparent to those skilled in the art and they are all anticipated and contemplated to be within the spirit and scope of the disclosed specification. For example, although specific embodiments have been described in detail, those with skill in the art will understand that the preceding embodiments and variations can be modified to incorporate various types of substitute and or additional or alternative materials, relative arrangement of elements, order of steps and additional steps, and dimensional configurations. Accordingly, even though only few variations of the products and methods are described herein, it is to be understood that the practice of such additional modifications and variations and the equivalents thereof, are within the spirit and scope of the method and products as defined in the following claims. The corresponding structures, materials, acts, and equivalents of all means or step plus function elements in the claims below are intended to include any structure, material, or acts for performing the functions in combination with other claimed elements as specifically claimed.

We claim:

1. A membrane support having a local surface roughness of less than 100 nanometers.

2. The support of claim 1, wherein the support comprises a ceramic.

3. The support of claim 1, wherein the support has a porosity of less than 50%.

4. The support of claim 1, wherein the support has a mechanical strength sufficient to support single or multiple layers of nano coating, to a total coating thickness of less than 2000 nm.

5. The support of claim 1, wherein the support further comprises a metal.

6. The support of claim 1, wherein the support further comprises a metal oxide.

7. The support of claim 1, wherein the support further comprises an inorganic-material selected from the inorganic materials including: Al, Al₂O₃, TiO₂, ZrO₂, BN, YSZ, Ni, NiO, SiO₂, PZT, PE, PP, PEI.

8. The support of claim 1, wherein the support has a local surface roughness of less than 100 nm on at least one side of a planar configuration.

9. The support of claim 1, wherein the support has a local surface roughness of less than 100 nm on at least two sides of a planar configuration.

10. The support of claim 1, wherein the support has a local surface roughness of less than 100 nm on at least one surface selected from the group of surfaces consisting of an inside surface and an outside surface of a tubular configuration.

11. The support of claim 1, wherein the support has a local surface roughness of less than 100 nm on both an inside surface and an outside surface of a tubular configuration.

12. The support of claim 1, wherein the support has a microstructure having a mechanical permeability of greater than 10⁻¹⁰ mol/(Pa·s·m²).

13. The support of claim 1, wherein the support has a surface deposition of at least one nano-thickness material having a thickness of between 25-500 nm.

14. The support of claim 1, wherein the support has a surface deposition of a plurality of layers having an aggregate thickness less than or equal to 2000 nm.

15. The support of claim 19, wherein the surface deposition comprises a polymer.

16. The support of claim 19 wherein the surface deposition comprises an inorganic material.

17. The support of claim 20, wherein the surface deposition comprises a polymer.

18. The support of claim 20, wherein the surface deposition comprises an inorganic material.

19. The support of claim 19, wherein the surface deposition is applied by a method selected from at least one of the group of methods consisting of dip coating, flow coating, spraying, and vapor deposition.

20. The support of claim 20, wherein the surface deposition is applied by a method selected from at least one of the group of methods consisting of dip coating, flow coating, spraying, and vapor deposition.
